(19) United States
(12) Patent Application Publication
(10) Pub. No.: US 2013/0258724 A1
(43) Pub. Date: Oct. 3, 2013

(54) HIGH VOLTAGE DIRECT CURRENT SYSTEM

(71) Applicants: Jie Shen, Bayern (DE); Stefan Schroeder, Munich (DE); Zhihui Yuan, Ismaning (DE)

(72) Inventors: Jie Shen, Bayern (DE); Stefan Schroeder, Munich (DE); Zhihui Yuan, Ismaning (DE)

(73) Assignee: GENERAL ELECTRIC COMPANY, Schenectady, NY (US)

(21) Appl. No.: 13/432,256

(22) Filed: Mar. 28, 2012

(51) Int. Cl. H02J 3/36

(52) U.S. Cl. 363/35

(57) ABSTRACT

A high voltage direct current system is presented. The system includes at least three high voltage direct current terminals. Furthermore, the system include at least two transmission lines configured to operatively couple the at least three high voltage direct current terminals. Moreover, the system includes a power flow control device operatively coupled to at least one end of one or more of the at least two transmission lines and at least one of a local grid and another power flow control device. Methods to perform the method for power flow control are also presented.

### BACKGROUND

The invention relates generally to a high voltage direct current system and more specifically to a multi-terminal high voltage direct current transmission and distribution system that employs enhanced power flow control.

Alternating current (AC) transmission and distribution systems are the most common solution for electric power transmission and distribution (T&D). Meshed AC transmission and distribution systems with variable power flow control (PFC) provide high reliability, redundancy and flexibility. In contrast, networking of high voltage direct current (HVDC) systems is challenging because the power flow control techniques used for AC transmission and distribution systems are not as effective for multi-terminal direct current (DC) transmission and distribution systems. The multi-terminal direct current (DC) transmission and distribution systems may include a ring type system, a mesh type system, a star type system, and the like. Consequently, the direct current (DC) transmission and distribution system is often limited to a point-to-point power transmission mode such as a conventional high voltage direct current (HVDC) transmission system. Thus, the direct current grid has been less extendable and less flexible than the alternating current transmission and distribution systems.

Current attempts to use power flow control for multi-terminal high voltage DC transmission and distribution systems use a modified universal power flow control (UPFC) technology, which is traditionally used for AC grids. The universal power flow control technology draws power from a transmission line to supply active power. Additionally, the universal power flow control technology uses a line frequency transformer. Hence, this power flow control technique is expensive to implement, bulky, and inflexible. Furthermore, in the direct current transmission and distribution system, a converter is generally coupled between a transmission line and ground. Unfortunately, these converters are costly to implement as they need to handle full transmission line voltage.

### BRIEF DESCRIPTION

In accordance with aspects of the present technique, high voltage direct current system is presented. The system includes at least three high voltage direct current terminals. Furthermore, the system include at least two transmission lines configured to operatively couple the at least three high voltage direct current terminals. Moreover, the system includes a power flow control device operatively coupled to at least one end of one or more of the at least two transmission lines and at least one of a local grid and another power flow control device.

In accordance with another aspect of the present technique, method for power flow control is presented. The method includes monitoring at least one line parameter corresponding to at least two transmission lines in a high voltage direct current system. Furthermore, the method includes processing the at least one line parameter corresponding to the at least two transmission lines with a reference parameter. Additionally, the method includes determining a balancing line parameter based on at least one line parameter and the reference parameter. The method also includes controlling the at least one line parameter in at least one of the two transmission lines by injecting the balancing line parameter using a power flow control device into at least one of the two transmission lines

In accordance with yet another aspect of the present technique, a high voltage direct current system is presented. The system includes a wind based power generation sub-system configured to generate electricity. To that end, the wind based power generation sub-system includes one or more wind turbines. Also, the system includes at least three high voltage direct current terminals. Furthermore, the system includes at least two transmission lines configured to operatively couple the at least three high voltage direct current terminals. In addition, the system includes a power flow control device operatively coupled to at least one end of one or more of the at least two transmission lines, and at least one of a local grid and another power flow control device. Furthermore, the power flow control device is configured to control flow of power in the at least two transmission lines.

### DRAWINGS

These and other features, aspects, and advantages of the present disclosure will become better understood when the following detailed description is read with reference to the accompanying drawings in which like characters represent like parts throughout the drawings, wherein:

FIG. 1 is a diagrammatic representation of an exemplary embodiment of a high voltage direct current system, according to aspects of the present disclosure;

FIG. 2 is a diagrammatic representation of an exemplary embodiment of a ring arrangement of a high voltage direct current system, according to aspects of the present disclosure;

FIG. 3 is a diagrammatic representation of an exemplary embodiment of a meshed high voltage direct current system, according to aspects of the present disclosure;

FIG. 4 is a diagrammatic representation of an exemplary embodiment of a high voltage direct current system with a closed path, according to aspects of the present disclosure;

FIG. 5 is a diagrammatic representation of an exemplary embodiment of a leg of the high voltage direct current system of FIG. 4 with direct current coupling, according to aspects of the present disclosure;

FIG. 6 is a diagrammatic representation of an exemplary embodiment of a direct current-direct current converter module for use in the high voltage system of FIG. 5, according to aspects of the present disclosure;

FIG. 7 is a diagrammatic representation of an exemplary embodiment of a leg of the high voltage direct current system of FIG. 4 with alternating current coupling, according to aspects of the present disclosure;

FIG. 8 is a diagrammatic representation of an exemplary embodiment of a leg of the high voltage direct current system of FIG. 4 without active power feed, according to aspects of the present disclosure; and

FIG. 9 is a flow chart representing a method for power flow control, according to aspects of the present disclosure.

### DETAILED DESCRIPTION

Unless defined otherwise, technical and scientific terms used herein have the same meaning as is commonly understood by one of ordinary skill in the art to which this disclosure belongs. The terms “first”, “second”, and the like, as used herein do not denote any order, quantity, or importance, but rather are used to distinguish one element from another. Also, the terms “a” and “an” do not denote a limitation of quantity, but rather denote the presence of at least one of the referenced items. The term “or” is meant to be inclusive and mean one, some, or all of the listed items. The use of “including,” “comprising” or “having” and variations thereof herein are meant to encompass the items listed thereafter and equivalents thereof as well as additional items. The terms “connected” and “coupled” are not restricted to physical or mechanical connections or couplings, and can include electrical connections or couplings, whether direct or indirect. Furthermore, the terms “circuit” and “circuitry” and “controller” may include either a single component or a plurality of components, which are either active and/or passive and are connected or otherwise coupled together to provide the described function.

As will be described in detail hereinafter, various embodiments of an exemplary high voltage direct current system and a method for power flow control are presented. By employing the high voltage direct current system and power flow control method described hereinafter, a high voltage direct current transmission and distribution system based grid can be widely established. Particularly, a ring type, a star type, a meshed type and equivalent multi-terminal high voltage direct current transmission and distribution systems may be established. The term multi-terminal as used herein may be representative of a system with two or more high voltage direct current terminals. The high voltage direct current transmission and distribution system with the power flow control described hereinafter may be used to provide a more reliable, more flexible, and less expensive system.

Embodiments disclosed herein relate generally to a high voltage direct current system. As used herein, the term high voltage direct current (HVDC) system is representative of a high voltage direct current transmission and distribution system. In one example, the high voltage direct current system includes at least three high voltage direct current terminals and at least two transmission lines. The three high voltage direct current terminals may in turn include a one or more converter modules. Also, the two transmission lines operatively couple the three high voltage direct current terminals. The high voltage direct current system further includes a power flow control device operatively coupled to one end of the one or more of the two transmission lines. The term operatively coupled as used herein includes wired coupling, wireless coupling, electrical coupling, magnetic coupling, radio communication, software based communication, or combinations thereof. The transmission lines may include an underground transmission line, an overhead transmission line, or a combination thereof.

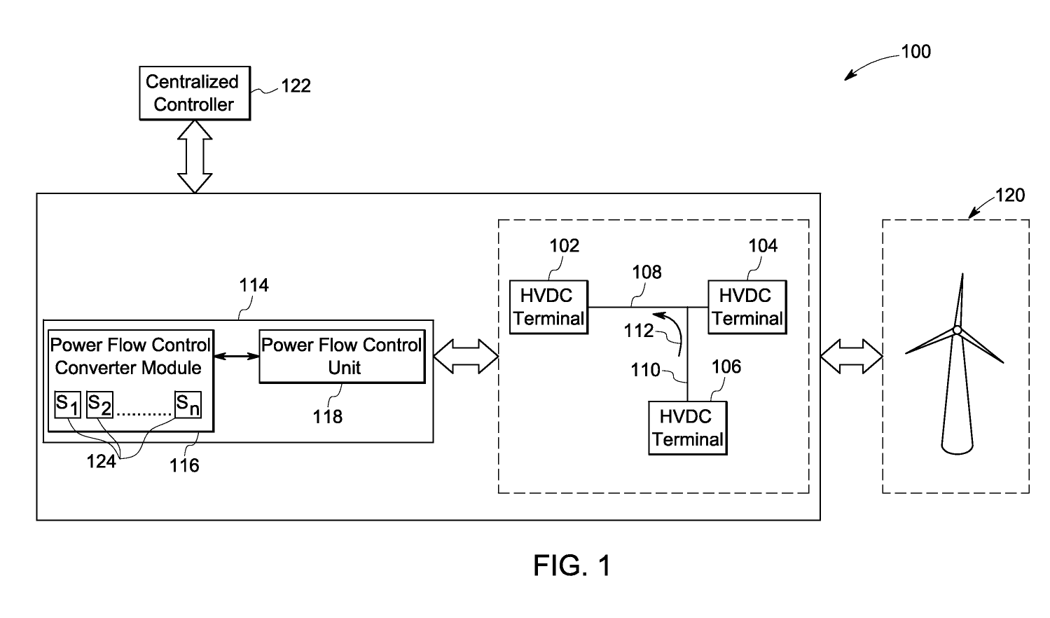

Turning now to the drawings, by way of example in FIG. 1, a schematic representation of an exemplary embodiment of a high voltage direct current (HVDC) system 100, in accordance with aspects of the present disclosure, is depicted. In one embodiment, the HVDC system 100 may include at least three high voltage direct current terminals. By way of example, the HVDC system 100 may include a first HVDC terminal 102, a second HVDC terminal 104, and a third HVDC terminal 106. Furthermore, the HVDC system 100 may include at least two transmission lines configured to couple the HVDC terminals 102, 104 and 106. By way of example, the high voltage direct current system 100 may include a first transmission line 108 and a second transmission line 110. As depicted in FIG. 1, the two transmission lines 108, 110 may be arranged to form an open path. For example, in the embodiment of FIG. 1, the first transmission line 108 and the second transmission line 110 may operatively couple the first HVDC terminal 102, the second HVDC terminal 104, and the third HVDC terminal 106 to form an open path 112. In certain other embodiments, more than two transmission lines may be employed to operatively couple the three HVDC terminals such that the more than two transmission lines form at least one closed path. In yet another embodiment, more than two transmission lines may be utilized to operatively couple more than three high voltage direct current terminals.

Furthermore, by way of a non-limiting example, the first transmission line 108 may be configured to operatively couple the first HVDC terminal 102 to the second HVDC terminal 104. In a similar fashion, the second transmission line 110 may be configured to operatively couple the second HVDC terminal 104 to the third HVDC terminal 106. Moreover, one or more of the first HVDC terminal 102, the second HVDC terminal 104, and the third HVDC terminal 106 may in turn include a one or more converter modules (not shown). The term converter modules as used herein may be used to refer to converter modules used in the high voltage direct current terminals 102, 104, 106. Also, as used herein, the term converter modules is used to refer to a module that converts one form of power to another form of power, such as conversion from DC to AC, conversion from a fixed value of DC to a variable value of DC, or the like. In accordance with one embodiment, one or more of the first HVDC terminal 102, the second HVDC terminal 104, and the third HVDC terminal 106 may also be a conventional HVDC substation, a non-modular substation, a grid, a power link, and the like.

In accordance with further aspects of the present disclosure, the HVDC system 100 may include a power flow control device 114. In the example of FIG. 1, the power flow control device 114 may be operatively coupled to either one or both of the first transmission line 108 and the second transmission line 110. Furthermore, in one embodiment, the power flow control device 114 may be operatively coupled to at least one of a local grid and another power flow control device. Also, the power flow control device 114 may be configured to control line parameters of the first transmission line 108, and the second transmission line 110, in one embodiment. In accordance with one embodiment, the power flow control device 114 in combination with other components of the HVDC system 100 may control line parameters in the first transmission line 108 and the second transmission line 110. The line parameters may be controlled to regulate the line parameters of a transmission line during an imbalance condition of the transmission lines 108, 110, for example. The imbalance condition of the transmission lines may be due to a short circuit in the transmission line, a broken transmission line, a sudden increase in market demand and the like. The line parameters may include a voltage, a current, power, or combinations thereof.

In a presently contemplated configuration, the power flow control device 114 may include a power flow control converter module 116 and a power flow control unit 118. The power flow control unit 118 may be configured to regulate operation of the power flow control converter module 116. In accordance with one embodiment, the power flow control converter module 116 and the power flow control unit 118 may be packaged as a single unit. However, in another embodiment, the power flow control converter module 116 and the power flow control unit 118 may exist as separate units. In accordance with yet another embodiment, the power flow control unit 118 may be in-built in the power flow control converter module 116.

Furthermore, in one embodiment, the power flow converter module 116 may be substantially similar to the one or more converter modules used in the high voltage direct current terminals 102, 104, 106. However, in another embodiment, the power flow control converter module 116 may be a variant of the converter modules. In accordance with one embodiment, the one or more converter modules and the power flow control converter module 116 may include an electrical power conversion system. The electrical power conversion system may include a direct current-direct current converter, a direct current-alternating current converter, an alternating current-direct current converter, a direct current-alternating current-direct current converter, or combinations thereof. Moreover, in one embodiment, the direct current-direct current converter may include a dual active bridge converter, a single active bridge converter, and the like. In yet another embodiment, the one or more converter modules and the power flow control converter module 116 may include a voltage source converter, a current source converter, or equivalents thereof. The one or more converter modules and the power flow control converter module 116 may also include a multi-level pulse width modulation converter, a two-level pulse width modulation converter, a three-level pulse width modulation converter, a multi-point converter, a neutral point clamped converter, or combinations thereof.

In addition, the one or more converter modules in the HVDC terminals 102, 104, 106 may include a plurality of switches (not shown). Furthermore, the power flow control device 114 and the power flow control converter module 116, in particular, may include a plurality of switches 124. In accordance with one embodiment, the plurality of switches may include a semiconductor switch. Also, the semiconductor switch may include silicon based switches, silicon carbide based switches, gallium nitride based switches, insulated gate bipolar transistors, metal oxide semiconductor field effect transistors, junction gate field effect transistors, or combinations thereof.

Additionally, in one embodiment, the power flow control unit 118 may include a computing device (not shown). As previously noted, the power flow control unit 118 is configured to control the operation of the power flow control converter module 116. To that end, the power flow control unit 118 may be configured to control a pattern of switching of the plurality of switches 124 in the power flow control converter module 116. Accordingly, the computing device may be configured to store and/or process the patterns of switching of the plurality of switches 124 in the power flow control converter module 116, in one example. This switching of the plurality of switches 124 in the power flow control converter module 116 aids in injecting respective line parameters to the transmission lines 108, 110 during the imbalance condition. In one non-limiting example, the pattern of switching may be based on a proportional control technique, a proportional-integral (PI) control technique, a proportional-integral-differential (PID) control technique, or combinations thereof. Furthermore, the computing device may include a computer, a processor, a digital signal processing (DSP) based system, or combinations thereof.

The power flow control device 114 may be configured to control the flow of power in the first and second transmission lines 108, 110. To that end, the power flow control device 114 may be configured to monitor the one or more line parameters corresponding to the transmission lines 108 and 110. As previously noted, the line parameter may include a voltage, a current, power, or combinations thereof. In one non-limiting example, the power flow control device 114 may be configured to monitor a current, a voltage and/or power in the transmission lines 108 and 110. To that end, the power flow control device 114 may include a current sensing device, a voltage sensing device, and/or a power sensing device. The current sensing device (not shown) may be used to monitor the current in the transmission lines 108 and 110. Similarly, the voltage sensing device (not shown) may be used to monitor the voltage in the transmission lines 108 and 110. In a similar fashion, the power sensing device may be used to monitor the power in the transmission lines 108 and 110. In accordance with one embodiment, the current sensing device, the voltage sensing device, and the power sensing device may be in-built in the power flow control device 114. However, in another embodiment, the current sensing device, the voltage sensing device, and the power sensing device may be disposed remote from the power flow control device 114.

Moreover, the one or more converter modules in the HVDC terminals 102, 104, 106 may include a control unit (not shown) configured to regulate operation of the one or more converter modules. In one embodiment, the power flow control unit 118 and the control unit corresponding to the one or more converter modules may be substantially the same. Furthermore, in another embodiment, the power flow control unit 118 and the control unit corresponding to the one or more converter modules may be packaged as a single unit. However, in yet another embodiment, the control unit corresponding to the one or more converter modules may be disposed remote from the high voltage direct current system 100.

In the presently contemplated configuration, the high voltage direct current system 100 may include a centralized controller 122 configured to control operation of the one or more converter modules and the power flow control device 114. The centralized controller 122 may be operatively coupled to the HVDC system 100 using a universal serial bus (USB) connection, an Ethernet connection, a wireless connection, a wired connection, and the like. In one embodiment, the centralized controller 122 may be disposed remote from the HVDC system 100.

Furthermore, the power flow control device 114 may be configured to control the flow of power in the first transmission line 108 and/or the second transmission line 110. As previously noted, the power flow control device 114 may be configured to monitor at least one line parameter (referenced hereinafter as a “first line parameter”) corresponding to either one or both of the two transmission lines 108 and 110. In addition, the power flow control device 114 may be configured to process the respective line parameters corresponding to the two transmission lines 108, 110 based on a reference parameter. The term processing as used herein may be a comparison, a subtraction, a summation, a modulus, a multiplication, a division, an integration, a differentiation, and other equivalent mathematical operations. In accordance with one embodiment, the reference parameter may be common for both the transmission lines 108 and 110. However, in another embodiment, each transmission lines 108, 110 may have a respective reference parameter. In one example, the power flow control unit 118 may be configured to process each of the first line parameters corresponding to the two transmission lines 108, 110 based on the reference parameter. The first line parameters and the reference parameter may include a voltage, a current, power, or combinations thereof. Additionally, the reference parameter may be stored in a data repository (not shown).

Moreover, the power flow control device 114 and the power flow control unit 118, in particular, may be configured to determine a second line parameter, based on the processing of the first line parameters with a corresponding reference parameter, for example. The second line parameter may generally be referred to as a balancing line parameter. In one embodiment, the reference parameter may include the first line parameter monitored at the other transmission line. In certain other embodiments, the reference parameter may include a determined line parameter corresponding to the first transmission line and/or the second transmission line. In this example, the determined line parameter may include a constant value of voltage, current, power, or combinations thereof.

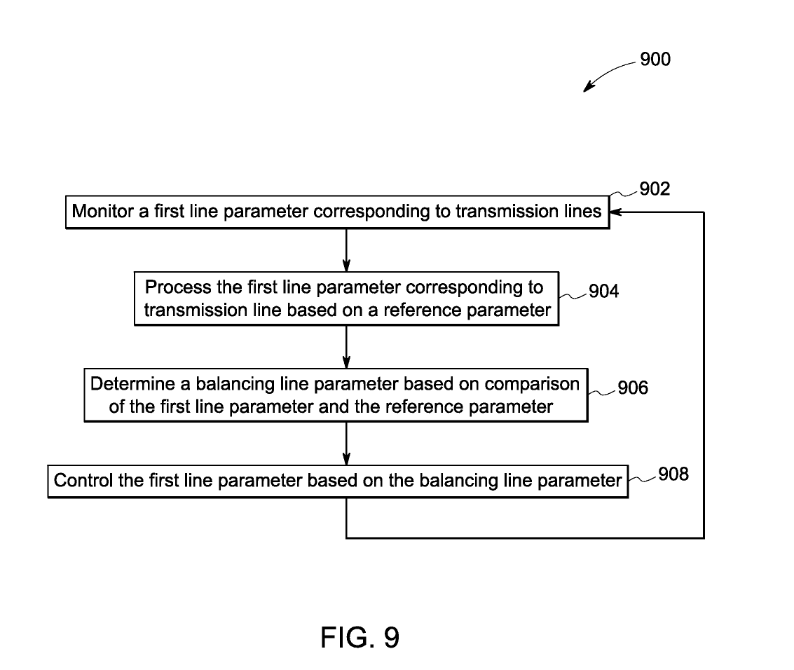

In accordance with further aspects of the present disclosure, the power flow control device 114 may be configured to inject the balancing line parameter into at least one of the two transmission lines 108, 110 to control a value of the first line parameter in that transmission line. In one non-limiting example, the power flow control converter module 116 of the power flow control device 114 may be configured to inject the balancing line parameter into at least one of the two transmission lines 108, 110 to control the value of the first line parameter in that transmission line and thereby control the flow of power in that transmission line. The term injection, as used herein, may include a direct injection, indirect injection, and the like. Furthermore, in one example, the balancing line parameter may be used as a feedback parameter by the power flow control unit 118 for controlling the operation of the power flow control converter module 116, which in turn aids in regulating the line parameters of the corresponding transmission lines. The process of control of the flow of power in the transmission lines is explained in greater detail with reference to FIG. 9.

Furthermore, it may be noted that the power flow control device 114 may have a first side and a second side. Also, the first side of the power flow control device 114 may have a first connector and a second connector. In accordance with further aspects of the present disclosure, the first connector (not shown) of the first side (not shown) of the power flow control device 114 may be operatively coupled to either one or both of the two transmission lines 108 and 110. Furthermore, the second connector (not shown) of the first side of the power flow control device 114 may be operatively coupled to at least one of the three HVDC terminals 102, 104, and 106. In addition, the second side (not shown) of the power flow control device 114 may be operatively coupled to a local grid. By way of example, the second side of the power flow control device 114 may be coupled to at least one of the local grid and another power flow control device via a direct current bus, an alternating current bus, or a combination thereof. In one embodiment, the local grid may be a wind based power generation system 120. The wind based power generation system 120 may include an onshore wind based power generation system, an off-shore wind based power generation system, or a combination thereof. However, in yet another embodiment, the local grid may include a local direct current grid, a local alternating current grid, a solar power plant system, a thermal power plant system, a hydrokinetic power system, or combinations thereof.

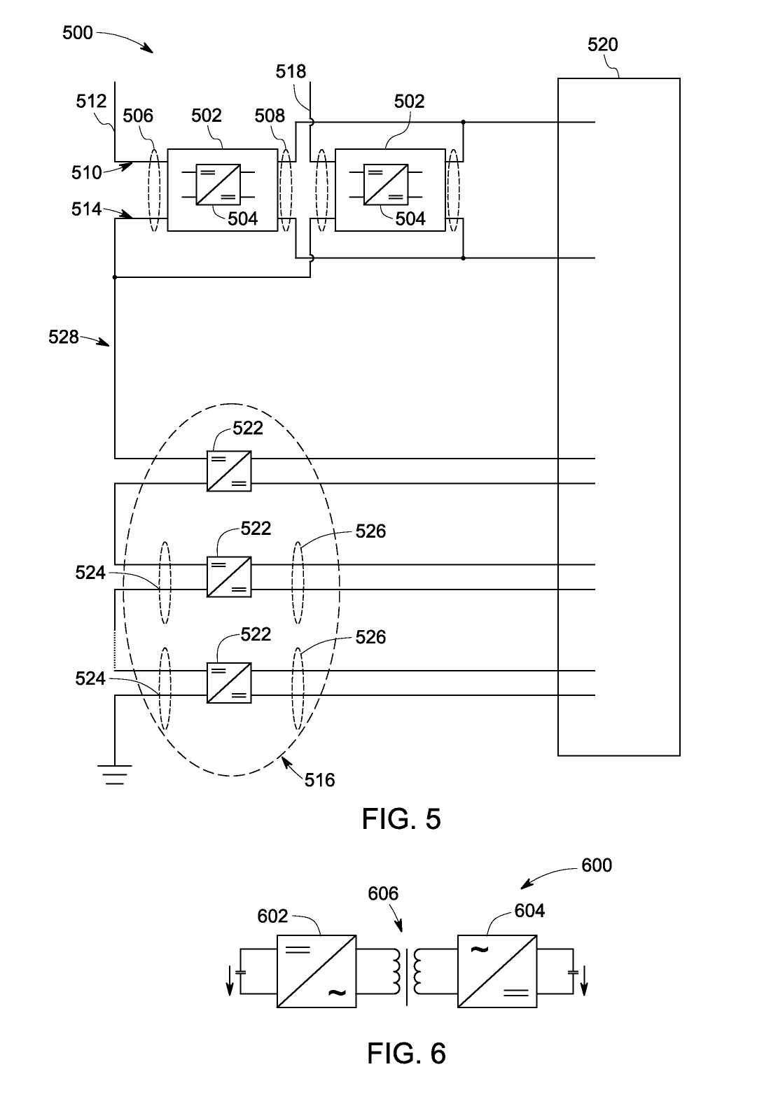

In addition, each HVDC terminal 102, 104, 106 may have a first end and a second end. As noted hereinabove, the first end (not shown) of one or more of the three high voltage direct current terminals 102, 104, 106 may be operatively coupled to the first side of the power flow control device 114. Furthermore, the second end of one or more of the three high voltage direct current terminals 102, 104, 106 may be operatively coupled to ground (not shown). Moreover, at least one of the HVDC terminals includes one or more converter modules, as previously noted. Also, each converter module may have a corresponding first side and second side. In one embodiment, a first side (not shown) of each of the one or more converter modules may be operatively coupled in series. Moreover, a second side (not shown) of each of the one or more converter modules may be operatively coupled in parallel, in series, or in a combination thereof. Furthermore, the second side of each of the one or more converter modules may be operatively coupled to the local grid. As previously noted, the power flow control device may be operatively coupled to at least one of a local grid and another power flow control device. Accordingly, the active power for the power flow control device 114 may be compensated from the local grid and/or the other power flow control devices, and not compensated from the transmission lines 108, 110. The arrangement of the high voltage direct current terminals, the transmission lines, the power flow control device 114, and the converter modules in the HVDC terminal, and in the high voltage direct current system 100 will be explained in greater detail with reference to FIGS. 5 and 7-8.

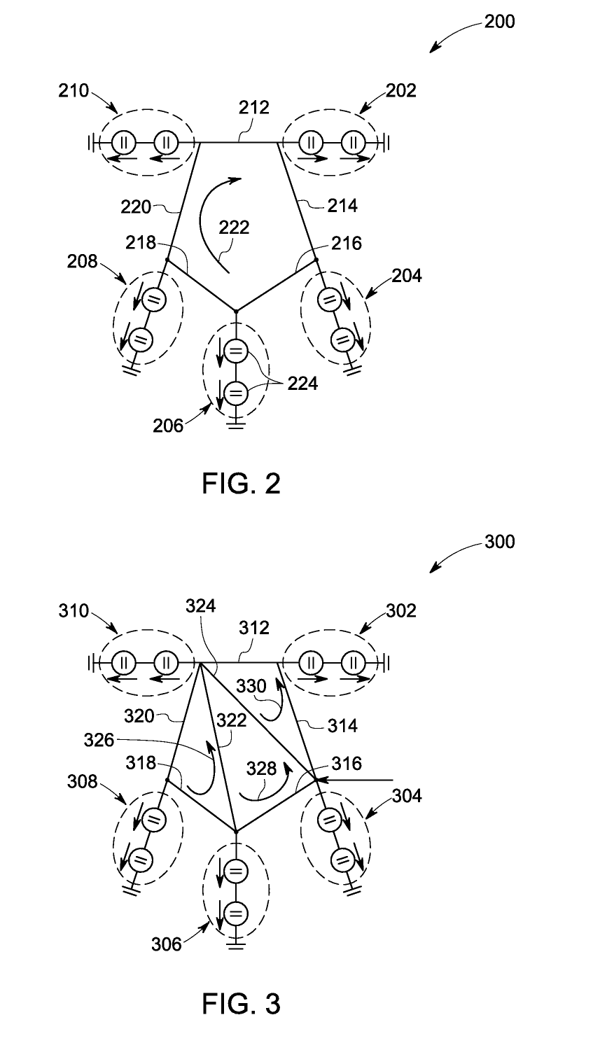

Referring now to FIG. 2, a ring arrangement 200 of a high voltage direct current system is depicted, by way of a non-limiting example. In the present example, the ring arrangement 200 of high voltage direct current system includes five high voltage direct current terminals 202, 204, 206, 208, and 210 and five transmission lines 212, 214, 216, 218, and 220. The five transmission lines 212, 214, 216, 218, and 220 are operatively coupled to the five high voltage direct current terminals 202, 204, 206, 208, and 210 such that the five transmission lines form at least one closed path 222. Moreover, in the example of FIG. 2, each of the high voltage direct current terminals 202, 204, 206, 208, and 210 is operatively coupled to at least two transmission lines. For example, the high voltage direct current terminal 202 is operatively coupled to one end of a first transmission line 212 and one end of a second transmission line 214.

Furthermore, one or more of the five high voltage direct current terminals 202, 204, 206, 208, and 210 may include a one or more converter modules 224. It may be noted that in one embodiment, the one or more converter modules 224 corresponding to each high voltage direct current terminal may be operatively coupled in a serial manner. Although, the example of FIG. 2, depicts use of five high voltage direct current terminals and five transmission lines, use of other numbers and/or configurations of high voltage direct current terminals that form a closed path is also contemplated. In one non-limiting example, the HVDC system 200 may include one or more high voltage direct current terminals operatively coupled to each other using one or more transmission lines, such that the one or more transmission lines form an open path.

Turning now to FIG. 3, a meshed arrangement 300 of a high voltage direct current system is depicted. In a presently contemplated configuration, the meshed arrangement 300 of high voltage direct current system includes five high voltage direct current terminals 302, 304, 206, 308, and 310 and seven transmission lines 312, 314, 316, 318, 320, 322, and 324. The seven transmission lines 312, 314, 316, 318, 320, 322, and 324 are utilized to operatively couple the five high voltage direct current terminals 302, 304, 206, 308, and 310 to form a first closed path 326, a second closed path 328, and a third closed path 330. Consequently, each high voltage direct current terminal may be coupled to one or more high voltage direct current terminals via the transmission lines. By way of example, the high voltage direct current terminal 304 is operatively coupled to one end of three transmission lines 314, 316, and 324, thereby coupling the high voltage direct current terminal 304 to high voltage direct current terminals 302, 306, and 310. Similarly, the high voltage direct current terminal 310 is operatively coupled to one end of four transmission lines 312, 320, 322, and 324. Hence, the high voltage direct current terminal 310 is operatively coupled to high voltage direct current terminals 302, 304, 306, and 308. It may be noted that, in one embodiment, a power flow control device (not shown) may be operatively coupled to one end and/or both ends of the corresponding transmission lines. Furthermore, in other embodiments, the power flow control device may be operatively coupled along a corresponding transmission line.

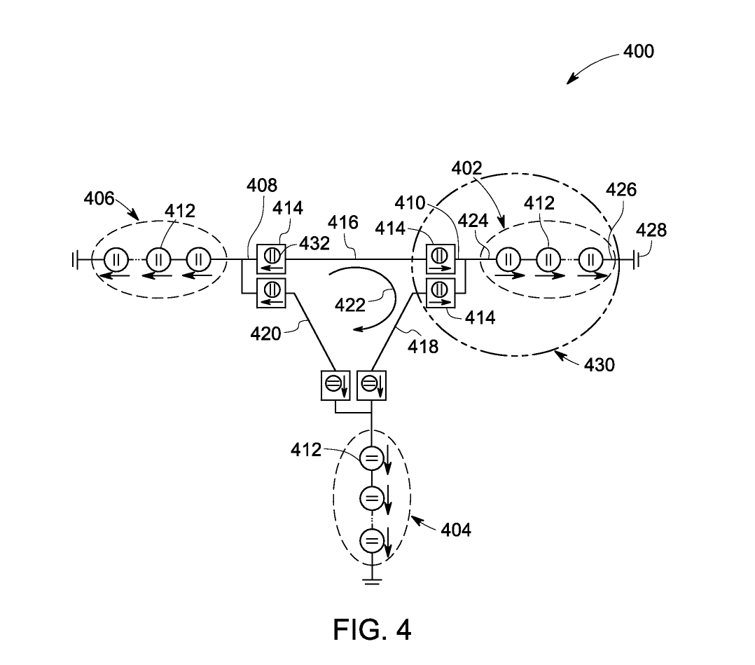

FIG. 4 is a diagrammatic representation 400 of an exemplary embodiment of a high voltage direct current system with a closed path, according to aspects of the present disclosure. In the embodiment of FIG. 4, the high voltage direct current system 400 includes a first high voltage direct current terminal 402, a second high voltage direct current terminal 404, a third high voltage direct current terminal 406. Additionally, the HVDC system 400 also includes a first transmission line 416, a second transmission line 418, and a third transmission line 420 that are employed to operatively couple the HVDC terminals 402, 404, 406. The first transmission line 416, the second transmission line 418, and the third transmission line 420 operatively couple the first high voltage direct current terminal 402, the second high voltage direct current terminal 404, and the third high voltage direct current terminal 406 to form a closed path 422. As previously noted, the first high voltage direct current terminal 402, the second high voltage direct current terminal 404, and the third high voltage direct current terminal 406 may include one or more converter modules. By way of example, in FIG. 4, the first high voltage direct current terminal 402 includes a one or more converter modules 412 operatively coupled in series. In one non-limiting example, the number of converter modules may vary from about 1 to about 100 converter modules.

Furthermore, a power flow control device 414 may be operatively coupled to one or more of the three transmission lines 416, 418, and 420. As previously noted, the power flow control device 414 may include a power flow control converter module 432 and a power flow control unit. It may be noted that the power flow control unit is not shown in FIG. 4 for ease of illustration. Moreover, by way of example in FIG. 4, the power flow control device 414 and the power flow control converter module 432, in particular, is operatively coupled to a first end 408 and another power flow control device 414 is operatively coupled to a second end 410 of the first transmission line 416. In a similar fashion, the power flow control device 414 may be operatively coupled to a first end, a second end or both the first end and the second end of the second transmission line 418 and/or the third transmission line 420.

In addition, a first end 424 of each of the HVDC terminals 402, 404, and 406 is operatively coupled to a corresponding power flow control device. Also, a second end of each of the HVDC terminals 402, 404, and 406 may be operatively coupled to ground. For example, in FIG. 4, the first end 424 of the first HVDC terminal 402 may be operatively coupled to the power flow control device 414, while the second end 426 of the first high voltage direct current terminal 402 may be operatively coupled to ground 428. In certain embodiments, the physical arrangement of the one or more converter modules 412 in one or more of the high voltage direct current terminals 402, 404, and 406 may be substantially similar. However, in other embodiments, the physical arrangement of the one or more converter modules 412 in the HVDC terminals 402, 404, and 406 may be different in each HVDC terminal. As used herein, the term physical arrangement of the one or more converter modules is used to refer to a coupling of the one or more converter modules. For example, the one or more converter modules may be operatively coupled in a parallel topology, a series topology, or a combination thereof. Furthermore, in one embodiment, the HVDC system 400 may also include other circuit components (not shown) such as a high frequency transformer, a line frequency transformer, a circuit breaker, an inductor, a compensator, a capacitor, a diode, a rectifier, a filter, a variable frequency transformer, and the like.

With continuing reference to FIG. 4, the HVDC terminals may be operatively coupled to two transmission lines via a corresponding power flow control device. By way of example, the first HVDC terminal 402 is operatively coupled to the first transmission line 416 and the second transmission line 418 via corresponding power flow control device 414. A portion of the first transmission line 416, a portion of the second transmission line 418 and their corresponding power flow control devices 414 are operatively coupled to form a leg 430 of the HVDC system 400.

FIG. 5 is a schematic representation of an exemplary embodiment of one leg 500 of a HVDC system, such as the leg 430 of FIG. 4. By way of example, the leg 500 of the HVDC system as represented in FIG. 5 includes two power flow control devices 502. Also, the power flow control device 502 includes a power flow control converter module 504 and a power flow control unit (not shown in FIG. 5 for ease of illustration). In one embodiment, the power flow control converter module 504 may include a direct current-direct current converter. The power flow control device 502 may have a first side 506 and a second side 508.

In accordance with one embodiment, the first side 506 may be a primary side and the second side 508 may be a secondary side. Also, in another embodiment, the primary side may be a direct current side and the secondary side may be an alternating current side. Furthermore, in one non-limiting example, a first connector 510 of the first side 506 of the power flow control device 502 is operatively coupled to a first transmission line 512. Also, a second connector 514 of the first side 506 of the power flow control device 502 is operatively coupled to a first high voltage direct current terminal 516. In one embodiment, the leg 500 of HVDC system may include more than one HVDC terminal 516. Also, in one embodiment, the HVDC terminal 516 may include a mono-polar configuration. However, in another embodiment, the HVDC terminal 516 may include a bi-polar configuration. The bi-polar configuration as used herein may have a positive voltage bus (not shown) and a negative voltage bus (not shown) along with a ground terminal. To that end, both the positive voltage bus and the negative bus may be operatively coupled to the power flow control device 502, which is in turn coupled to transmission lines 512, 518. It may be noted that the second sides 508 of the power flow control devices 502, may be operatively coupled to one another in a parallel manner. Furthermore, the second side 508 of the power flow control device 502 may also be operatively coupled to a local grid 520. In the example of FIG. 5, the power flow control converter module 504 may be a direct current-direct current converter. The coupling of the second side 508 of the power flow control device 502 and particularly, a second side of the power flow converter module 504 may be referred to as a direct current coupling. As previously noted, the local grid 520 may include a local direct current grid, a local alternating current grid, a solar power plant system, a wind based power generation system, a thermal power plant system, a hydrokinetic power system, or combinations thereof.

With continuing reference to FIG. 5, the first high voltage direct current terminal 516 includes a one or more converter modules 522. In one embodiment, the converter modules 522 may be direct current-direct current converters. First sides 524 of the converter modules 522 may be operatively coupled in series. Additionally, second sides 526 of the converter modules 522 may be operatively coupled in parallel. Alternatively, in one embodiment, the second sides 526 of the converter modules 522 may be operatively coupled in series. Also, the second sides 526 of the converter modules 522 may be operatively coupled in a combination of series and parallel connections. In yet another embodiment, the second sides 526 of the converter modules 522 may not be operatively coupled to one another. The second sides 526 of the converter modules 522 may further be operatively coupled to the local grid 520. In one embodiment, the converter modules 522 and the power flow control converter modules 504 may include substantially similar modules, thereby providing a flexible high voltage direct current system.

Implementing the HVDC system as described in FIG. 5 aids in substantially reducing a desired voltage isolation for the power flow control converter module 504 and the one or more converter modules 522. It may be noted that the voltage across each of the converter modules 522 is a small value since the voltage between the transmission line and the ground is evenly distributed across each of the converter modules 522 that are operatively coupled in series with each other. Consequently, the voltage across a topmost converter module may be a substantially smaller value in comparison to a total transmission line voltage. As previously noted, the second connector 514 of the first side 506 of each power flow control device 502 is operatively coupled to a first end 528 of the HVDC terminal 516. Consequently, the voltage across the power flow control converter module 504 is also a substantially smaller value when compared to the total transmission line voltage. Accordingly, use of a transformer for voltage isolation may be circumvented because of the relatively smaller value of voltage across each of the converters modules 522 and/or the power flow control converter modules 504. Alternatively, in one embodiment, a high frequency transformer, a line frequency transformer or any other equivalent small sized transformer may be used for isolation, thereby providing a compact and cheaper high voltage direct current system.

FIG. 6 is a representation of an exemplary embodiment of a direct current-direct current converter module 600, configured for use as the power flow control converter module 504 of FIG. 5. In one embodiment, the direct current-direct current converter module 600 includes a direct current-alternating current converter 602. Furthermore, the direct current-direct current converter module 600 also includes an alternating current-direct current converter 604. In addition, the direct current-alternating current converter 602 may be operatively coupled to the alternating current-direct current converter 604 via a transformer 606. As previously noted, the need for voltage isolation may be substantially minimal and/or reduced for the high voltage direct current system. Hence, the transformer 606 may be a high frequency transformer, a line frequency transformer, or any other equivalent small sized transformer.

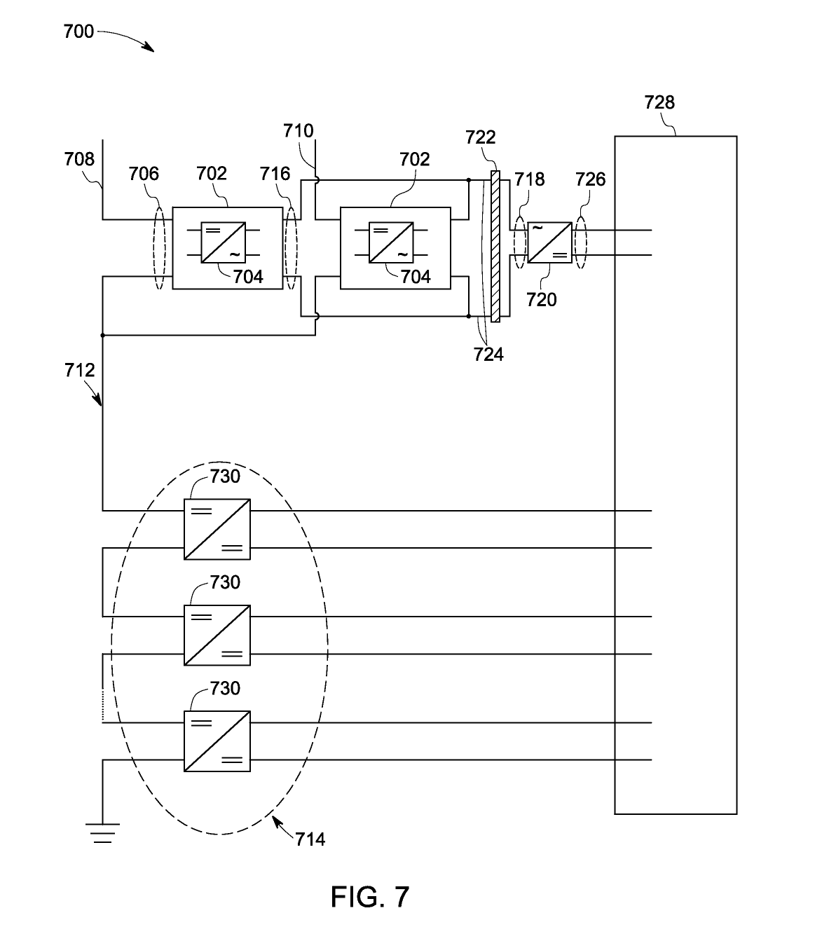

Turning now to FIG. 7, an exemplary embodiment 700 of a leg of the high voltage direct current system with alternating current coupling is depicted. By way of example, the leg 700 of the high voltage direct current system, as represented in FIG. 7, includes two power flow control devices 702. As previously noted, the power flow control device 702 may include a power flow control converter module 704 and a power flow control unit (not shown). In one embodiment, the power flow control converter module 704 is a direct current-alternating current converter.

In one embodiment, first sides 706 of the power flow control devices 702 may be operatively coupled to a corresponding transmission line 708 and 710 and a first end 712 of a HVDC terminal 714. In addition, second sides 716 of the power flow control devices 702 may be operatively coupled in parallel to one another. The second sides 716 of the power flow control devices 702 may also be operatively coupled to a first side 718 of an alternating current-direct current converter module 720. In one embodiment, second sides 716 of the power flow control devices 702 may be operatively coupled to the first side 718 of the AC to DC converter module 720 via a transformer 722. Moreover, the second sides 716 of the power flow control devices 702 may be operatively coupled to the first side 718 of the AC to DC converter module 720 using a low voltage alternating current bus 724. A second side 726 of the alternating current-direct current converter module 720 may be operatively coupled to a local grid 728. However, in certain embodiments, the second side 726 of the alternating current-direct current converter module 720 may not be operatively coupled to the local grid 728. Furthermore, the HVDC terminal 714 may include one or more converter modules 730. In one non-limiting example, the one or more converter modules 730 may include a direct current to direct current converter.

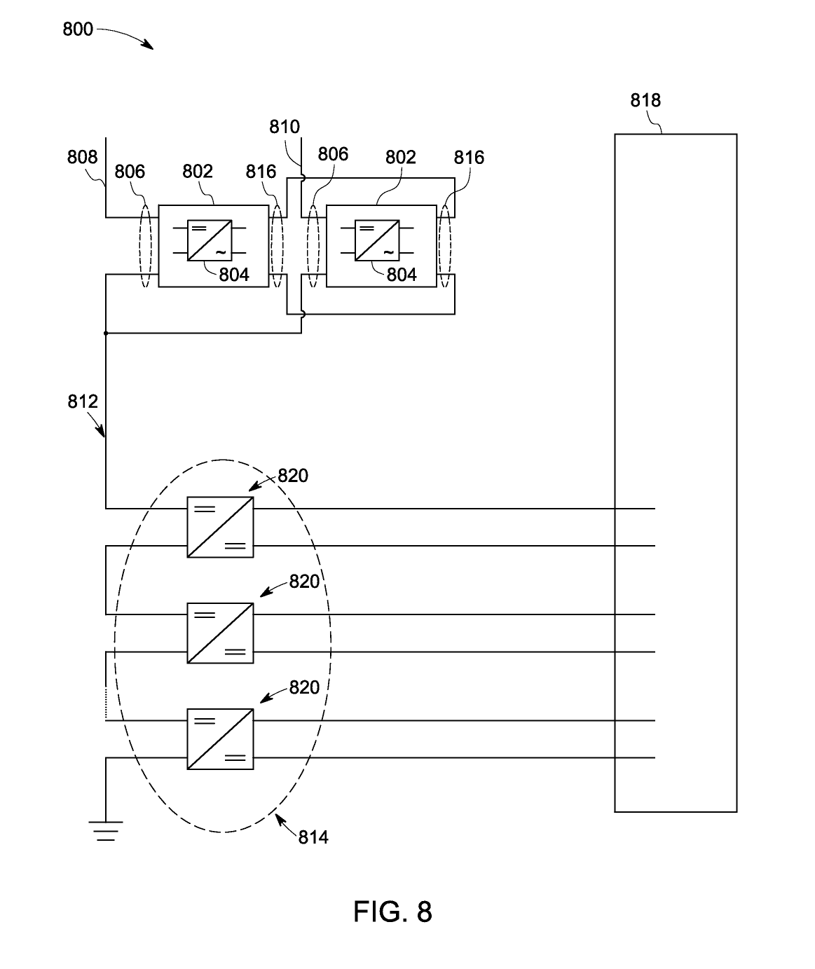

FIG. 8 is a representation of an exemplary embodiment 800 of a leg of a HVDC system without an active power feed. As used herein, the term active power feed is used to refer to feeding of power to one or more power flow control devices in the HVDC system to or from a local grid. By way of example, the leg 800 of the high voltage direct current system as represented in FIG. 8 includes two power flow control devices 802. As previously noted, the power flow control device 802 includes a power flow control converter module 804 and a power flow control unit (not shown). In accordance with one embodiment, a centralized controller (such as centralized controller 122 of FIG. 1) may be configured to control the operation of the power flow converter module 804 instead of the power flow control unit. In one embodiment, the power flow control converter module 804 may be a direct current-alternating current converter. In accordance with yet another embodiment, the power flow control converter module 804 may be a direct current- direct current converter. However, in other embodiments, the power flow control converter module 804 may include a four quadrature direct current-direct current converter, a four quadrature alternating current-alternating current converter, or combinations thereof. First sides 806 of the power flow control devices 802 may be operatively coupled to a corresponding transmission line 808 and 810. In addition, the first sides 806 of the power flow control devices 802 may also be coupled to a first end 812 of a corresponding HVDC terminal 814. Second sides 816 of the power flow control devices 802 may be operatively coupled to one another in parallel. It may be noted that, in the embodiment of FIG. 8, the second side 816 of each of the power flow control devices 802 is not operatively coupled to the local grid 818. Since the second side 816 of the power flow control device 802 is not coupled to the local grid 818, active power is not fed from the local grid 818 to the power flow control devices 802 or vice versa. Accordingly, in the embodiment of FIG. 8, the active power feed for the power flow control devices 802 may not be provided by the local grid 818. However, the active power feed to the power flow control devices 802 may instead be compensated from other power flow control devices that are operatively coupled in parallel. In this case, the total power demand of the power flow control devices 802 from an external source, such as the local grid 818 or the transmission lines 808, 810, may be a substantially low value or zero. Moreover, since the embodiment of FIG. 8 does not rely on the local grid 818, the HVDC system 800 is easier to implement.

Furthermore, in one embodiment, the second sides 816 of the power flow control devices 802 may not be operatively coupled to each other. Instead, the second side 816 of each of the power flow control devices 802 may be operatively coupled to the local grid 818. In one embodiment, the control of the power flow control converter modules 804 and converter modules 820 in the HVDC system 800 may be thereby regulated by a centralized controller.

FIG. 9 is a flow chart 900 depicting an exemplary method for power flow control. In one embodiment, the power flow control in a HVDC system, such as the HVDC system 100 of FIG. 1, may be coordinated by a power flow control device, such as the power flow control device 114 of FIG. 1. For ease of understanding, the power flow control method is described with reference to the elements of FIG. 4. The method begins at a step 902, where a power flow control device 414 and more particularly a power flow control unit (not shown) is configured to continuously monitor at least one line parameter generally referred to as a first line parameter corresponding to a first transmission line 416, a second transmission line 418, and a third transmission line 420. In one embodiment, the first line parameters corresponding to the first, the second, and the third transmission lines 416, 418, 420 may be monitored simultaneously. In another embodiment, the first line parameters corresponding to the first, the second, and the third transmission lines 416, 418, 420 may be monitored at different instants in time. Furthermore, in one embodiment, the first line parameter corresponding to the three transmission lines 416, 418, 420 may be monitored at determined periodic intervals. Also, as previously noted, the first line parameter may include a voltage, current, power, or combinations thereof.

Subsequently, at step 904, the first line parameter corresponding to the first transmission line 416, the second transmission line 418 and the third transmission line 420 may be processed based on a reference parameter. The term processed as used herein may include a comparison, a subtraction, a summation, a modulus, a multiplication, a division, an integration, a differentiation, and other equivalent mathematical operations. Accordingly, as previously noted, the reference parameter may be representative of a threshold or reference value. Also, the reference parameter may include a voltage, a current, power or combinations thereof. In accordance with one embodiment, the reference parameter may be common for the transmission lines 416, 418, 420. However, in another embodiment, each transmission line 416, 418, 420 may have a respective reference parameter.

As noted hereinabove, the reference parameter may include the monitored first line parameter corresponding to the other transmission lines. For example, at step 904, the first line parameter of the first transmission line 416 may be compared with the first line parameter corresponding to the second transmission line 418 and/or the third transmission line 420. Also, the reference parameter may include a determined line parameter corresponding to the first transmission line 416, the second transmission line 418 and/or the third transmission line 420. In this example, the determined line parameter may include a constant value of voltage, current, power, or combinations thereof. However, the determined line parameter may also include a variable value of voltage, current, power, or combinations thereof. The variable value of voltage, current, power, or combinations thereof may be determined based on one or more of an imbalance of voltage at the transmission lines, imbalance of current at the transmission lines, imbalance of power at the transmission lines at any instant in time, market demand of electricity, grid codes and the like. Also, an imbalance of voltage at the transmission lines, imbalance of current at the transmission lines, imbalance of power at the transmission lines at any instant in time may include conditions such as a broken transmission line, a short circuit in transmission line, and the like. In one example, the power flow control device and particularly, the power flow control unit may be used to perform step 904.

In addition, at step 906, based on processing of the first line parameter associated with a transmission line with the corresponding reference parameter or a common reference parameter, a balancing line parameter corresponding to that transmission line may be determined In one example, the power flow control device 414 and particularly, the power flow control unit may be used to perform step 906. In accordance with one embodiment, the steps 902 through 906 may be performed by a centralized controller (such as centralized controller 122 of FIG. 1).

Moreover, at step 908, a value of first line parameter in one or more transmission lines may be controlled. In particular, the balancing line parameter corresponding to a transmission line that is determined at step 906 may be injected into the transmission line to control the value of the first line parameter in that transmission line. As previously noted, the balancing line parameter corresponding to the first transmission line 416 may be injected into the first transmission line 416 at step 908 by a power flow control device. Similarly, balancing line parameters corresponding to the second and third transmission lines 418, 420 determined at step 906 may be injected into the corresponding transmission lines to control the respective first line parameters. In one embodiment, the balancing line parameter may include a voltage, a current, power, or combinations thereof. Also, the balancing line parameter corresponding to the transmission lines may be substantially different or similar. Steps 902-908 may be repeated until desired results are obtained and/or for a determined period of time. Also, steps 902-908 may be referred to as a power flow control cycle.

In one non-limiting example, the balancing line parameter corresponding to the transmission lines may be injected into the corresponding transmission lines by a power flow control converter module such as the power flow control converter module 432 of FIG. 4. The power flow control converter module, as previously noted, may include a plurality of switches. Subsequent to the determination of the balancing line parameter, a switching pattern for switching the plurality of switches of the power flow control device and the power flow control converter module, in particular, may be identified. The plurality of switches in the power flow control converter module may then be energized based on the selected switching pattern to allow the balancing line parameter to be injected into the corresponding transmission lines by the power flow control converter module. As previously noted, the injection of the balancing line parameter into the transmission line by the power flow control converter module controls the first line parameter corresponding to that transmission line. By way of example, in the HVDC system with three transmission lines, it may be desirable to enhance or reduce the power flow in one transmission line as a result of a sudden increase or decrease in the market demand of electricity. In accordance with aspects of the present disclosure, the balancing line parameter in the form of a voltage may be injected by the power flow control converter module into the corresponding transmission lines to enhance or reduce the voltage in that transmission line. Upon injection of the voltage to the transmission line, the voltage, and therefore the current and the flow of power in that transmission line may be controlled. In one embodiment, the flow of power in a particular transmission line may also be controlled by using a converter module, such as converter module 412 of FIG. 4.

Furthermore, the foregoing examples, demonstrations, and process steps such as those that may be performed by the system may be implemented by suitable code on a processor-based system, such as a general-purpose or special-purpose computer. It should also be noted that different implementations of the present technique may perform some or all of the steps described herein in different orders or substantially concurrently, that is, in parallel. Furthermore, the functions may be implemented in a variety of programming languages, including but not limited to C++ or Java. Such code may be stored or adapted for storage on one or more tangible, machine readable media, such as on data repository chips, local or remote hard disks, optical disks (that is, CDs or DVDs), memory or other media, which may be accessed by a processor-based system to execute the stored code. Note that the tangible media may comprise paper or another suitable medium upon which the instructions are printed. For instance, the instructions may be electronically captured via optical scanning of the paper or other medium, then compiled, interpreted or otherwise processed in a suitable manner if necessary, and then stored in the data repository or memory.

The HVDC systems and the methods of power flow control described hereinabove aids in developing/establishing meshed HVDC systems, thereby allowing extension of the HVDC based grid. Furthermore, since the HVDC system calls for minimal voltage isolation, a compact system may be provided. Also, use of substantially similar converter modules in the HVDC terminals and the power flow control devices provides a flexible high voltage direct current system. Moreover, the power flow control devices are low in cost, thereby providing a less expensive HVDC system. The HVDC system described hereinabove may find application in solar, wind, and other renewable power generation systems. Also, the HVDC system may be employed in non-renewable power generation systems like thermal power plants, hydroelectric power plants and equivalents thereof. In addition, the HVDC system may also be used in DC transmission and distribution system using modular DC-DC converters in series at a high voltage side, such as in an off-shore wind farm. Furthermore, the active power for the power flow control devices is compensated from the local grid and/or the other power flow control devices, and not compensated from the transmission lines.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A high voltage direct current system, comprising:
at least three high voltage direct current terminals;
at least two transmission lines configured to operatively couple the at least three high voltage direct current terminals; and
a power flow control device operatively coupled to at least one end of one or more of the at least two transmission lines and at least one of a local grid and another power flow control device.

2. The system of claim 1, further comprising a centralized controller configured to control operation of the power flow control device.

3. The system of claim 1, wherein the power flow control device is configured to perform the steps of:
monitoring at least one line parameter corresponding to the at least two transmission lines; and
processing the at least one line parameter corresponding to the at least two transmission lines based on a reference parameter.

4. The system of claim 3, wherein the power flow control device is configured to perform the step of determining a balancing line parameter based on the processing of the at least one line parameter and the reference parameter.

5. The system of claim 4, wherein the power flow control device is configured to inject the balancing line parameter into at least one of the at least two transmission lines to control a corresponding line parameter.

6. The system of claim 4, wherein the at least one line parameter, the reference parameter, and the balancing line parameter comprise power, voltage, current or combinations thereof.

7. The system of claim 1, wherein a first connector of a first side of the power flow control device is operatively coupled to at least one of the at least two transmission lines, and wherein a second connector of a first side of the power flow control device is operatively coupled to at least one of the at least three high voltage direct current terminals.

8. The system of claim 1, wherein a second side of the power flow control device is operatively coupled to a second side of another power flow control device, the local grid, or a combination thereof

9. The system of claim 1, wherein one end of the at least three high voltage direct current terminals is operatively coupled to ground.

10. The system of claim 1, wherein the power flow control device comprises a plurality of switches, and wherein the plurality of switches comprises semiconductor switches.

11. The system of claim 1, wherein at least one of the at least three high voltage direct current terminals comprises one or more converter modules.

12. The system of claim 11, wherein first sides of the one or more converter modules in the high voltage direct current terminals are operatively coupled in series, and wherein second sides of the one or more converter modules in the high voltage direct current terminals are operatively coupled in parallel, in series, or in a combination thereof.

13. The system of claim 11, wherein the one or more converter modules comprises voltage source converters, current source converters, or a combination thereof.

14. The system of claim 11, wherein the one or more converter modules comprises a direct current-direct current converter, a direct current-alternating current converter, an alternating current-direct current converter, a direct current-alternating current-direct current converter, or combinations thereof.

15. The system of claim 1, wherein the local grid comprises a local direct current grid, a local alternating current grid, a solar power plant system, a wind based power generation system, a thermal power plant system, a hydrokinetic power system, or combinations thereof.

16. A method for power flow control, comprising:
monitoring at least one line parameter corresponding to at least two transmission lines in a high voltage direct current system;
processing the at least one line parameter corresponding to the at least two transmission lines with a reference parameter;
determining a balancing line parameter based on at least one line parameter and the reference parameter; and
controlling the at least one line parameter in at least one of the two transmission lines by injecting the balancing line parameter using a power flow control device into at least one of the two transmission lines.

17. The method of claim 16, wherein injecting the balancing line parameter comprises:
selecting a switching pattern of a plurality of switches in the power flow control device based on the determined balancing line parameter; and
energizing one or more of the plurality of switches based on the selected pattern.

18. The method of claim 16, wherein processing the at least one line parameter corresponding to the at least two transmission lines with the reference parameter comprises performing a step of comparison, subtraction, summation, modulus, multiplication, division, integration, differentiation, or combinations thereof.

19. The method of claim 16, further comprising compensating active power for the power flow control device from at least one of a local grid and another power flow control device, and not compensating the active power from the at least two transmission lines.

20. A high voltage direct current system, comprising:
a wind based power generation sub-system configured to generate electricity, wherein the wind based power generation sub-system comprises one or more wind turbines;
at least three high voltage direct current terminals;
at least two transmission lines configured to operatively couple the at least three high voltage direct current terminals; and
a power flow control device operatively coupled to at least one end of one or more of the at least two transmission lines, and at least one of a local grid and another power flow control device, wherein the power flow control device is configured to control flow of power in the at least two transmission lines.
